(19) United States
(12) Patent Application Publication
(10) Pub. No.: US 2025/0104356 A1
(43) Pub. Date: Mar. 27, 2025

(54) METHODS AND SYSTEMS FOR THREE-DIMENSIONAL (3D) INSPECTION

(71) Applicant: Cognex Corporation, Natick, MA (US)

(72) Inventors: Daniel Alejandro Moreno, Northbridge, MA (US); Hongwei Zhu, Natick, MA (US); Martin Schaufuß, Erfurt (DE); Ali Zadeh, Hopkinton, MA (US); Michael C. Moed, Hopkinton, MA (US); Chenye Li, Waltham, MA (US)

(73) Assignee: Cognex Corporation, Natick, MA (US)

(21) Appl. No.: 18/891,849

(22) Filed: Sep. 20, 2024

Related U.S. Application Data
(60) Provisional application No. 63/584,625, filed on Sep. 22, 2023.

(51) Int. Cl. G06T 17/20; G06T 7/00; G06V 10/44; G06V 10/764

(52) U.S. Cl. CPC G06T 17/20; G06T 7/0002; G06V 10/44; G06V 10/764; G06T 2207/30168

(57) ABSTRACT

The techniques described herein relate to methods and systems for three-dimensional (3D) inspection using deep learning model pre-trained with two-dimensional (2D) images. The techniques include transforming a 3D representation (e.g., captured 3D point cloud, 3D profiles, meshes, voxels) to a 2D map, which can be input to a deep learning model pre-trained with 2D images. The 2D map includes elements disposed in an array. Each element includes a vector of a number of geometric features. Such a configuration enables the 2D map to be in a structure acceptable by the 2D deep learning model. The 2D deep learning model generates an output based on the 2D map and provides the output to a subsystem for generating an inspection result. The inspection result can have a 3D result such as a surface area and/or volume.

### RELATED APPLICATION

This application claims priority under 35 U.S.C. § 119 (e) to U.S. Provisional Application Ser. No. 63/584,625, titled “METHODS AND SYSTEMS FOR THREE-DIMENSIONAL (3D) INSPECTION,” filed on Sep. 22, 2023, which is herein incorporated by reference in its entirety.

### FIELD

The techniques described herein relate generally to methods and systems for three-dimensional (3D) inspection, including methods and systems for 3D inspection using a deep learning model that is pre-trained with two-dimensional (2D) images.

### BACKGROUND

Machine vision systems are generally configured to receive and/or capture images of a scene. Some images, such as 3D point clouds, may have three-dimensional (3D) information, and some images such as RGB images may have two-dimensional (2D) information. Machine vision systems are also generally configured to analyze the images to perform one or more machine vision tasks. For example, machine vision systems can be configured to receive or capture images of objects and to analyze the images to identify the objects (e.g., to classify objects) and/or inspect the objects (e.g., for possible manufacturing defects). As another example, machine vision systems can be configured to receive or capture images of symbols and to analyze the images to decode the symbols. Accordingly, machine vision systems generally include one or more devices for image acquisition and image processing.

### SUMMARY

Aspects of the present disclosure relate to methods and systems for three-dimensional (3D) inspection.

Some embodiments relate to a method for three-dimensional (3D) inspection using a two-dimensional (2D) deep learning model. The method can comprise accessing the 2D deep learning model, wherein the 2D deep learning model was pre-trained using 2D images unrelated to an inspection task (for the 3D inspection); receiving a 3D representation of a scene; transforming the 3D representation to a 2D map, wherein the 2D map comprises a plurality of elements disposed in an array (e.g., rectangular array), and each of the plurality of elements comprises a vector of a geometric feature computed from the 3D representation; providing the 2D map to the 2D deep learning model to generate an output; and providing the output to a subsystem for generating an inspection result for the 3D representation.

Optionally, the 3D representation comprises a 3D point cloud, a mesh, sensor data, and/or a voxel grid.

Optionally, the 3D representation of the scene includes one or more 3D profiles. Optionally, one or more 3D profiles may be extracted from the 3D representation.

Optionally, the 3D representation of the scene comprises one or more 3D profiles comprising a plurality of 3D points, wherein each 3D point is obtained from an initial 3D representation of the scene based on an associated polyline.

Optionally, transforming the 3D representation comprises transforming the one or more 3D profiles to the 2D map.

Optionally, the inspection result is based on the one or more 3D profiles.

Optionally, the geometric feature comprises: a distance of an associated 3D point of the 3D representation to a reference; a surface normal vector of the associated 3D point; and/or a curvature associated with the 3D point.

Optionally, the reference is a plane, a hemisphere, a cylindrical surface, or a quadratic surface.

Optionally, for each of the plurality of elements: the vector comprises a number of geometric features; and the number of geometric features is one, two, or three.

Optionally, transforming the 3D representation to the 2D map comprises: determining a portion or plurality of portions of the 3D representation that corresponds to one of the plurality of elements of the 2D map; and for the portion or plurality of portions, computing the vector of the geometric feature for the corresponding element of the 2D map.

Optionally, the 3D representation comprises a 3D point cloud comprising a plurality of 3D points; and for the portion or each of the plurality of portions, computing the vector of the geometric feature for the corresponding element comprises: computing the geometric feature for the 3D points in the portion; and determining the vector of the geometric feature for the corresponding element based on the computed geometric feature for the 3D points in the portion.

Optionally, transforming the 3D representation to the 2D map comprises: projecting the computed vectors for the plurality of elements to a plane.

Optionally, the inspection result comprises a 3D result.

Optionally, the 3D result comprises one or more of a height, surface area, center of mass, volume, and/or 3D bounding box in the 3D representation.

Optionally, the method further comprises classifying an object via the subsystem.

Optionally, the method further comprises determining, via the subsystem, whether the object is in the 3D representation of the scene.

Optionally, the method further comprises identifying, via the subsystem, a possible defect(s) of an object.

Optionally, the inspection result comprises a segment or set of segments of the 3D representation (of the scene that are) associated with the possible defects.

Optionally, the 2D deep learning model and/or the subsystem comprises a back-end component that maintains an adjustable parameter.

Optionally, the method can comprise: adjusting the parameter(s) based on the inspection result generated by the subsystem.

Optionally, the method can comprise: adjusting the parameter(s) based on a training set of 2D maps.

Optionally, the inspection result comprises a quality metric; and the method comprises modifying the geometric feature (in an element) based on the quality metric.

Optionally, modifying the geometric feature (in an element) based on the quality metric comprises a brute force search, a greedy search, or a gradient-descent optimization, such that a value of the quality metric is modified such as increased and/or decreased (e.g., according to optimization of a function or value, such as minimizing a function).

Some embodiments relate to a method for three-dimensional (3D) inspection using a two-dimensional (2D) deep learning model. The method can comprise accessing one or more 3D profiles, wherein the one or more 3D profiles comprise a plurality of 3D points, wherein each 3D point is obtained from an initial 3D representation of a scene based on an associated polyline; transforming the one or more 3D profiles to a 2D map, wherein the 2D map represents a dimension of each of the plurality of 3D points using a geometric feature; providing the 2D map to the 2D deep learning model to generate an output from the 2D deep learning model; and generating, based on the output from the 2D deep learning model, an inspection result based on the one or more 3D profiles.

Optionally, the associated polyline comprises points with non-zero values in a vertical axis of a coordinate frame.

Optionally, the method further comprises deriving the one or more 3D profiles from an initial 3D representation, wherein the initial 3D representation comprises a 3D point cloud, a mesh, sensor data, and/or a voxel grid.

Optionally, the method further comprises, after deriving the one or more 3D profiles, performing an up-sampling operation to create a second 3D profile.

Optionally, the method further comprises interpolating points of the 3D point cloud, mesh, sensor data, and/or voxel grid to create the second 3D profile.

Optionally, the method further comprises aligning a plurality of the one or more 3D profiles prior to transforming the one or more 3D profiles into the 2D map.

Optionally, the method further comprises creating a score map based on the output from the 2D deep learning model.

Optionally, accessing the one or more 3D profiles includes accessing a sample comprising a plurality of 3D profiles.

Optionally, the 2D map represents the dimension of each of the 3D points of the plurality of 3D points using the geometric feature corresponding to a format of a grayscale image on a plane perpendicular to the vertical axis of the coordinate frame.

Optionally, the one or more 3D profiles comprise a plurality of sets of 3D points.

Some embodiments relate to a system comprising at least one processor configured to perform one or more operations described herein.

Some embodiments relate to a non-transitory computer readable medium comprising program instructions that, when executed, cause at least one processor to perform one or more operations described herein.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram illustrating a machine vision system, according to some embodiments.

FIG. 2 is a block diagram of an exemplary system for three-dimensional (3D) inspection, according to some embodiments.

FIG. 3 is a block diagram of an exemplary two-dimensional (2D) map generator of the system for 3D inspection of FIG. 2, according to some embodiments.

FIG. 4 is a schematic diagram illustrating an exemplary 2D map provided by the 2D map generator of FIG. 3, according to some embodiments.

FIG. 5 is a schematic diagram illustrating an exemplary processing by a projection generator of the 2D map generator of FIG. 3, according to some embodiments.

FIG. 6A are side images of an object with two lids, showing one lid open and both lids closed, respectively.

FIG. 6B are respective top images of the object with two lids shown in FIG. 6A.

FIGS. 6C-6G are respective 2D maps of the object with two lids shown in FIG. 6A, according to some embodiments.

FIG. 7A is a 3D point cloud of a connector in an exemplary region of interest.

FIG. 7B is a 2D map of the connector of FIG. 7A, according to some embodiments.

FIG. 7C is another 2D map of the connector of FIG. 7A, according to some embodiments.

FIG. 8A is a 3D point cloud of a bottle in an exemplary region of interest.

FIG. 8B is a 2D map of the bottle of FIG. 8A, according to some embodiments.

FIG. 8C is another 2D map of the bottle of FIG. 8A, according to some embodiments.

FIG. 9A is a 3D point cloud of an oil filter.

FIG. 9B is a 2D map of the oil filter shown in FIG. 9A, according to some embodiments.

FIG. 9C is a segmentation mask that can be generated based on the 2D map shown in FIG. 9B, according to some embodiments.

FIG. 10A is a 3D point cloud of a tote.

FIG. 10B is a 2D map of the tote shown in FIG. 10A, according to some embodiments.

FIG. 10C is a segmentation mask that can be generated based on the 2D map shown in FIG. 10B, according to some embodiments.

FIG. 11A is a 3D point cloud of a battery surface.

FIG. 11B is a 2D map of the battery surface shown in FIG. 11A, according to some embodiments.

FIG. 11C is a segmentation mask that can be generated based on the 2D map shown in FIG. 11B, according to some embodiments.

FIG. 12 is an image illustrating a method of generating a 3D profile, according to some embodiments.

FIG. 13 is a flow chart illustrating an exemplary method of generating a 2D map from 3D profiles with the 2D map generator of FIG. 3, according to some embodiments.

FIG. 14A shows images illustrating exemplary profiles on a point cloud in a 3D view.

FIGS. 14B-14D show profile arrangements corresponding to the exemplary profiles shown in FIG. 14A.

FIG. 14E shows an example of a projection feature map.

FIG. 15 is a flow chart illustrating an exemplary method of providing inspection results based on output of the 2D deep learning model with the subsystem of FIG. 3, according to some embodiments.

FIG. 16 shows an example of a score map that may be generated according to the method of FIG. 15.

FIGS. 17A-17B are images illustrating generating defect inspection results of a point cloud according to the methods of FIGS. 13 and 15.

FIG. 18 is a block diagram illustrating a method of training the 3D deep learning model of FIG. 3.

### DETAILED DESCRIPTION

Three-dimensional (3D) representations of a scene, such as 3D point clouds, provide popular representations of a scene using 3D information, such as (x, y, z) positions. The scene can include, for example, objects under inspection or analysis, and can be observed by a 3D sensor that produces a 3D point cloud, connected mesh and/or some other 3D representation of the scene. With the development of deep learning technologies, it can be desirable to analyze these 3D representations with deep learning-based approaches. For example, it can be desirable for machine vision applications to take into account shape features such as surface curvature, surface normal directions, and/or height, which can be represented in a 3D representation. The techniques described herein provide methods and systems for 3D machine vision applications using a deep learning model that is pre-trained with traditional two-dimensional (2D) images. Examples of such machine vision applications include 3D object inspection and/or 3D object classification.

A conventional deep learning model can include a chain of signal processing filters. Each filter can be applied in sequence to transform an input data structure into a desired output. For instance, the input could be a 2D image and the output could be a defect segmentation mask (e.g., for inspection applications), or a probability of the input belonging to a given category (e.g., for classification applications). These models can include convolutional filters, which can be configured relatively easily and applied to uniformly spaced grids such as 2D images.

It is, however, challenging to develop deep learning models that can process 3D representations. In particular, 3D representations are often not as structured as 2D images. For example, 3D point clouds often include massive numbers of 3D points and typically do not include information about structural or spatial relationships among the 3D points. Directly interpreting such a massive number of 3D points in space can therefore be quite time consuming and resource intensive. Trying to interpret a pure 3D point cloud can therefore be infeasible for many machine vision applications, which may have limited time to perform such interpretations, limited hardware resources, and/or the like. Some conventional techniques may first mesh the 3D points to generate surfaces along the 3D points and then perform geometrical operations based on the meshed surfaces. However, meshing the 3D points can require performing complex operations. Further, the resulting mesh surfaces can include noise artifacts (e.g., due to noisy 3D points that do not lie along the actual surface of the imaged objects) and therefore can also be difficult to interpret. Additionally, it is not always clear how to specify convolutional filters for non-2D representations and/or in the absence of a regular grid, such as unstructured point clouds. It is therefore often difficult and time consuming to develop deep learning models that accept 3D representations.

As a result, 3D deep learning models are often developed for, and thus limited to, specific applications. For example, some conventional 3D deep learning approaches for 3D representations use networks that are specially designed to receive inputs in an original format such as CT scan volumes, LIDAR acquisitions, and/or a list of 3D points (e.g., PointNet). As another example, some approaches generate a set of image views from a 3D representation and propose special network architectures to process these sets (e.g., sometimes referred to as multi-view deep learning). As a result, such conventional approaches require the creation of custom and specific network architectures to handle the sets of multiple scene views. As a result, such techniques are not easily adapted for use with new or different applications.

The techniques described herein provide for leveraging pre-trained 2D deep learning models to process 3D representations. The techniques can include transforming a 3D representation to a 2D map, which can be input to a deep learning model pre-trained using 2D images since the 2D map is formatted as a data structure that such deep learning models can accept for processing. In some examples, the 3D representation may be a 3D profile. The 2D images used for training can be (entirely) unrelated to the 3D application. For example, the 2D images can be from any set or collection of 2D images (e.g., of basic scenes, objects, etc.) that are not related to target object(s) of the 3D machine vision application (e.g., machined parts, manufactured components, etc.). As a result, the techniques can leverage existing 2D network architectures for 3D machine vision applications. The 2D map can include elements disposed in an array that are compatible with the processing of standard 2D images. Of note, the techniques do not convert the 3D representation into a 2D “image” as if it were captured by a 2D imaging device. Rather, while the 2D map could be viewed using a traditional image processing tool, the 2D map likely does not visually appear like a 2D image because the values stored in the pixel positions correspond to features that are calculated from the input point cloud (e.g., surface normal unit vectors). In some examples, the 2D map values may be calculated using cross-sectional profiles extracted from the input point cloud. Each element of the 2D map can include a vector of a number of geometric features. Such a configuration enables the 2D map to be in a structure acceptable by the 2D deep learning model, while representing feature information that is relevant to the 3D machine vision application.

The pre-trained 2D deep learning model can be adapted to process the 2D maps. To adapt the pre-trained 2D deep learning model, an edge learning approach can be used to customize the pre-trained 2D deep learning model using a limited (small) set of 2D representations (e.g., 2D maps) associated with the desired application (e.g., 2D representations of good/bad components for an inspection application). A component, such as a back-end component of and/or associated with the 2D deep learning model, can be modified using 2D representations in order to adapt the 2D deep learning model to process the 2D maps. A transformation technique can be used to transform 3D representations of the desired application to 2D representations. The 2D deep learning model generates an output based on the 2D map and provides the output to a subsystem (e.g., inspection subsystem) for generating an inspection result. The inspection result can have a 3D result, which can comprise one or more of a height, surface area, center of mass, volume, and 3D bounding box in the 3D representation.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

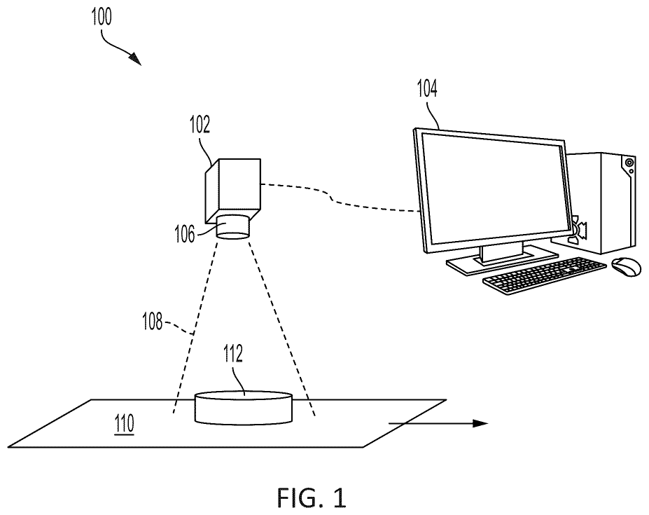

FIG. 1 shows an exemplary machine vision system 100, according to some embodiments. The exemplary machine vision system 100 includes a camera 102 (or other imaging acquisition device) and a computer 104. While only one camera 102 is shown in FIG. 1, it should be appreciated that a plurality of cameras can be used in the machine vision system (e.g., where a point cloud is merged from that of multiple cameras). The computer 104 includes one or more processors and a human-machine interface in the form of a computer display and optionally one or more input devices (e.g., a keyboard, a mouse, a track ball, etc.). Camera 102 includes, among other components, a lens 106 and a camera sensor element (not illustrated). The lens 106 includes a field of view 108, and the lens 106 focuses light from the field of view 108 onto the sensor element. The sensor element generates a digital image of the camera field of view 108 and provides that image to a processor that forms part of computer 104. The sensor element can include at least one processor configured to perform one or more operations described herein. As shown in the example of FIG. 1, object 112 travels along a conveyor 110 into the field of view 108 of the camera 102. The camera 102 can generate one or more digital images of the object 112 while it is in the field of view 108 for processing, as discussed further herein. In operation, the conveyor can contain a plurality of objects. These objects can pass, in turn, within the field of view 108 of the camera 102, such as during an inspection process. As such, the camera 102 can acquire at least one image of each observed object 112.

In some embodiments, the camera 102 is a three-dimensional (3D) imaging device. As an example, the camera 102 can be a 3D sensor that scans a scene line-by-line, such as the DS-line of laser profiler 3D displacement sensors, the In-Sight 3D-L4000, and/or the In-Sight L38 3D Vision System available from Cognex Corp., the assignee of the present application. According to some embodiments, the 3D imaging device can generate a set of (x, y, z) points (e.g., where the z axis adds a third dimension, such as a distance from the 3D imaging device). The 3D imaging device can use various 3D image generation techniques, such as shape-from-shading, stereo imaging, time of flight techniques, projector-based techniques, and/or other 3D generation technologies. In some embodiments the machine vision system 100 includes a two-dimensional (2D) imaging device, such as a 2D CCD or CMOS imaging array. In some embodiments, two-dimensional imaging devices generate a 2D array of brightness values.

In some embodiments, the machine vision system processes the 3D data from the camera 102. The 3D data received from the camera 102 can include, for example, a point cloud and/or a range image. A point cloud can include a group of 3D points that are on or near the surface of a solid object. For example, the points may be presented in terms of their coordinates in a rectilinear or other coordinate system. In some embodiments, other information, such as a mesh or grid structure indicating which points are neighbors on the object's surface, may optionally also be present. In some embodiments, the 2D and/or 3D data may be obtained from a 2D and/or 3D sensor, from a CAD or other solid model, and/or by preprocessing range images, 2D images, and/or other images.

According to some embodiments, the group of 3D points can be a portion of a 3D point cloud within user specified regions of interest and/or include data specifying the region of interest in the 3D point cloud. For example, since a 3D point cloud can include so many points, it can be desirable to specify and/or define one or more regions of interest (e.g., to limit the space to which the techniques described herein are applied).

Examples of computer 104 can include, but are not limited to a single server computer, a series of server computers, a single personal computer, a series of personal computers, a mini computer, a mainframe computer, and/or a computing cloud. The various components of computer 104 can execute one or more operating systems, examples of which can include but are not limited to: Microsoft Windows Server™; Novell Netware™; Redhat Linux™, Unix, and/or a custom operating system, for example. The one or more processors of the computer 104 can be configured to process operations stored in memory connected to the one or more processors. The memory can include, but is not limited to, a hard disk drive; a flash drive, a tape drive; an optical drive; a RAID array; a random access memory (RAM); and a read-only memory (ROM).

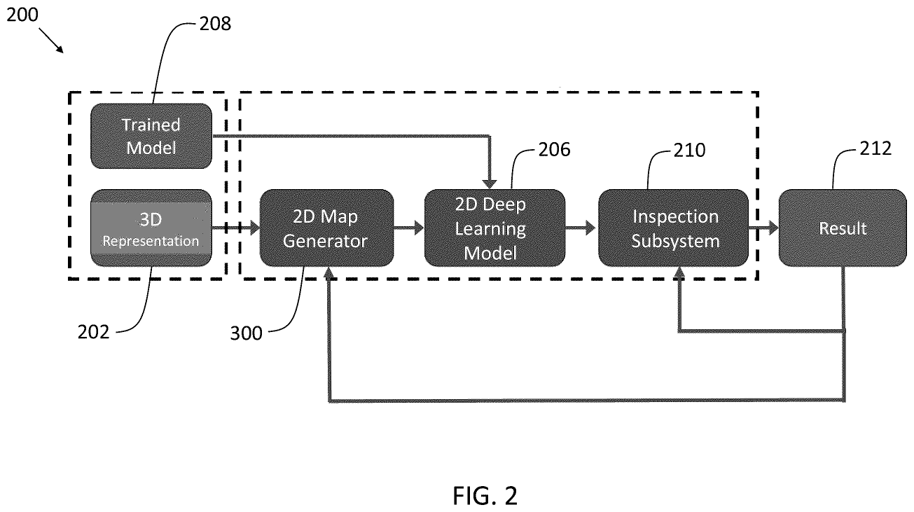

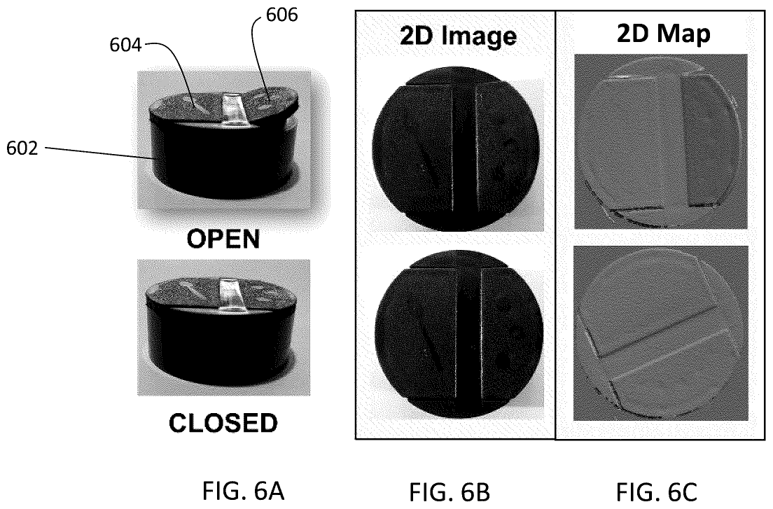

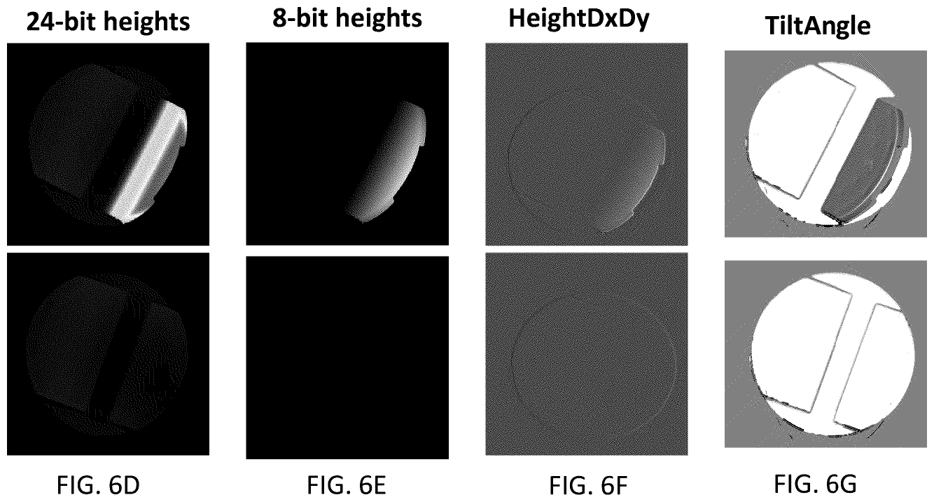

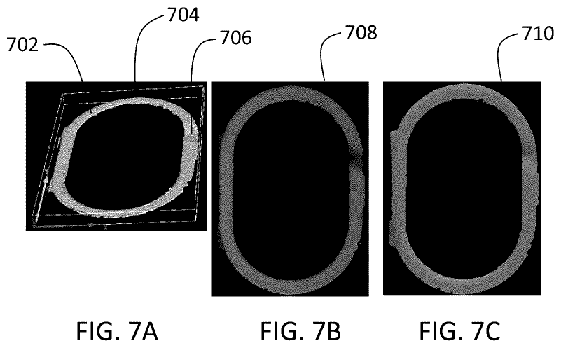

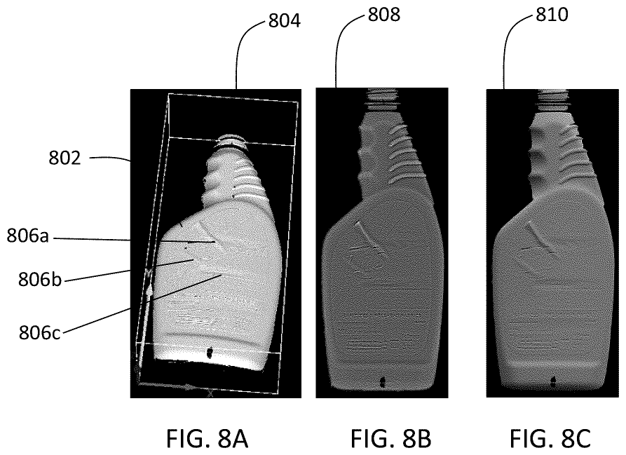

FIG. 2 is a block diagram of an exemplary system 200 for 3D inspection, according to some embodiments. According to some embodiments, the exemplary system 200 can be configured for a 3D inspection task such as a classification task and/or a segmentation task. For instance, the system 200 can be configured to inspect an object, or a scene with multiple objects, and provide an inspection result (e.g., report if defects are found or not), such that an operator and/or an automated system can take appropriate action(s) depending on the inspection result (e.g., to separate a defective part). The inspection tasks can vary from application to application. For example, some applications can be configured to identify cosmetic defects like dents and cracks (see, e.g., FIGS. 7A-8C). As another example, some applications can be configured to verify whether a part is correctly assembled (e.g., if all required screws are present and tight, or if bottles have their caps correctly placed) (see, e.g., FIGS. 6A-6C).

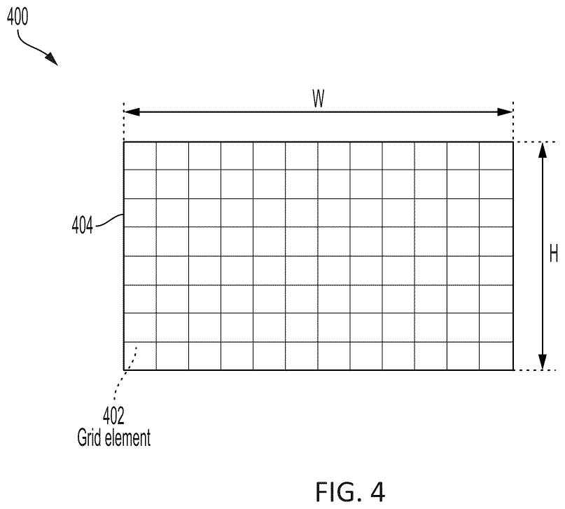

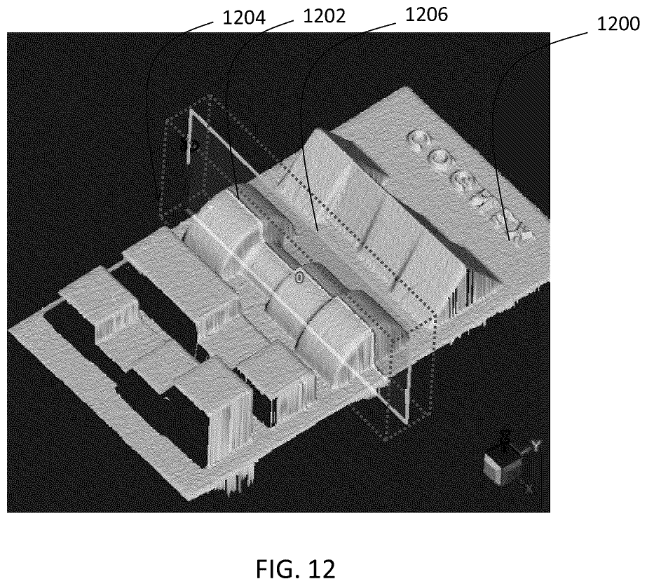

The techniques described herein provide for leveraging pre-trained 2D deep learning models, which are trained using 2D images that are not related to the specific machine vision application, to process 3D representations. As a result, the techniques do not require developing customized 3D deep learning models for individual inspection tasks. As illustrated, the exemplary system 200 can include a 2D map generator 300, a 2D deep learning model 206, and a subsystem 210 indicated as an inspection subsystem, as an example. The 2D map generator 300 can receive and/or access a 3D representation 202 of a scene, such as 3D point clouds, meshes, voxel grids, sensor data, etc., and transform the 3D representation 202 of the scene to a 2D map (e.g., the 2D map 400 shown in FIG. 4). The 3D representation 202 may be selected according to one or more inspection tasks. For example, the 3D representation 202 may include a captured 3D point cloud, and/or one or more 3D profiles extracted from the captured 3D point cloud (e.g., as described in relation to the 2D polyline 1202 shown in FIG. 12). In more detail, input to the 2D map generator 300 may be a complete 3D point cloud, in some examples, or may be a set of 3D profiles, in some examples. The 2D map can be configured to be compatible with the data format of regular 2D images (e.g., grayscale or RGB images) such that the 2D map can be processed by the 2D deep learning model 206. In some embodiments, the 2D map can include elements (e.g., element 402 in FIG. 4) disposed in a rectangular array (e.g., array 404 with a width W and a height H in FIG. 4).

The 2D map generator may be configured to generate the 2D map as a 2D projection image based on projection parameters. The transformation type, such as the projection type, and corresponding parameters may be obtained and used to generate the 2D projection image.

Each element 402 can include a vector of one or more geometric features computed from the 3D representation 202 of the scene. Examples of geometric features include, but are not limited to, a distance of an associated 3D point of the 3D representation 202 to a reference, a surface normal vector of the associated 3D point, and a curvature associated with the 3D point. Examples of a reference include, but are not limited to, a point, a line, a plane, a hemisphere, a cylindrical surface, or a quadratic surface. In some embodiments, the number of geometric features in the vector can be in a range of one to three features, corresponding to the format of grayscale and/or RGB images. For example, when the number of geometric features in the vector is one, the 2D map can be configured corresponding to the format of a grayscale image; when the number of geometric features in the vector is two, a third channel of the vector can be set to zero or a suitable constant value such that the 2D map can be configured corresponding to the format of an RGB image; and when the number of geometric features in the vector is three, the 2D map can be configured corresponding to the format of an RGB image. In some embodiments, the geometric features in the vector can be determined/adjusted based on the inspection task that the system 200 is configured to perform (see, e.g., FIGS. 6A-8C). For example, the vector may include, for an object classification task, a distance of an associated 3D point of the 3D representation 202 to a reference and, for identifying a surface cosmetic defect, both the distance of the 3D point to the reference and a curvature associated with the 3D point.

The 2D deep learning model 206 can generate an output based on the 2D map and provide the output to the subsystem 210 for generating an inspection result 212 and/or for post-processing. The output of the 2D deep learning model 206 can include 2D information about the scene. In some embodiments, the 2D deep learning model 206 can include a model 208 pre-trained using regular 2D images that can be unrelated to the inspection tasks.

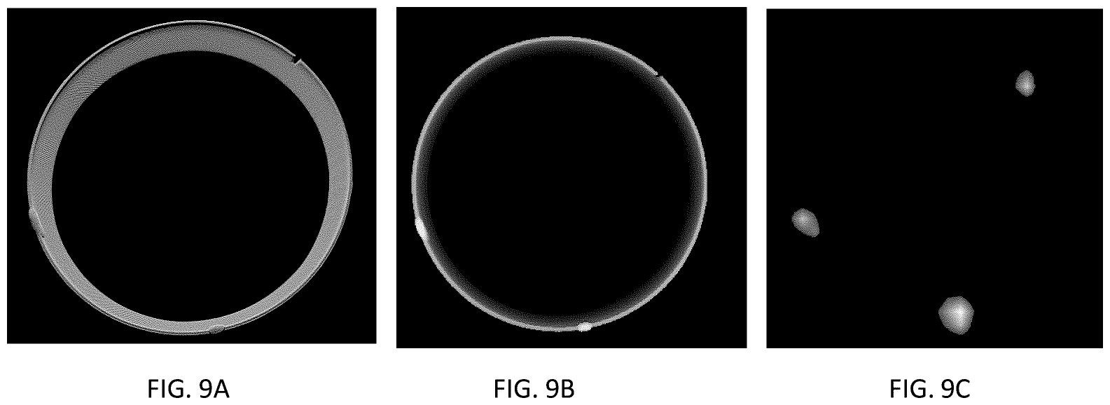

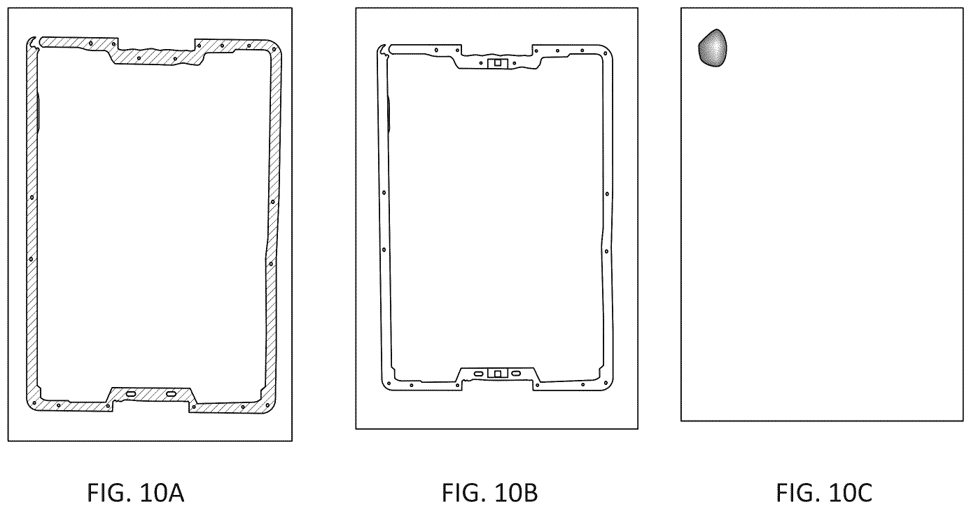

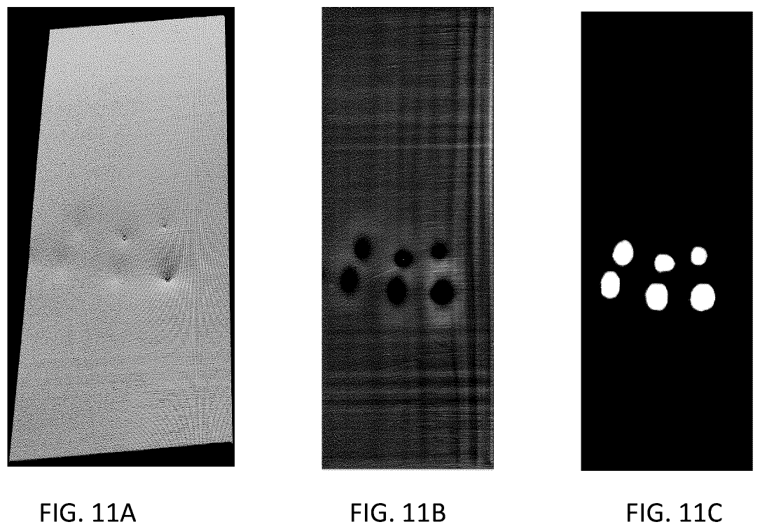

The subsystem 210 can be configured to relate the 2D information about the scene in the output of the 2D deep learning model 206 to the 3D representation 202, and/or to filter the output of the 2D deep learning model 206 according to user defined criteria. For example, the inspection result 212 can be a category label for the inspected scene like “PASS” and “FAIL”, or it could be a segmentation mask indicating the 3D region where a defect has been found (e.g., FIGS. 9C, 10C, 11C), with a corresponding classification label (e.g., “dent” or “crack”).

The 2D deep learning model 206 and/or the subsystem 210 can be adapted according to the inspection task that the system 200 is configured to perform. An edge learning approach can be used to customize the 2D deep learning model 206 and/or the subsystem 210, using a limited (small) set of 2D representations associated with the inspection task that the system 200 is configured for (e.g., 2D representations of good/bad components with corresponding labels for an inspection application). For example, five to ten 2D maps can be sufficient to customize the 2D deep learning model 206 and/or the subsystem 210 for most inspection tasks. In some instances, one or two 2D maps can give reasonable results. For example, an edge learning approach can be used to customize the 2D deep learning model 206 and/or the subsystem 210 to provide for each pixel labels that indicate, e.g., flaws (such as dents and/or scratches), regions determinations, and foreign object detections. As another example, an edge learning approach can be used to customize the 2D deep learning model 206 and/or the subsystem 210 to recognize optical characters that can be in a variety of formats (e.g., direct part marking, hazard label text, rotated text). As a further example, an edge learning approach can be used to customize the 2D deep learning model 206 and/or the subsystem 210 to robustly detect product instances (e.g., number of test tubes in a tray, number of empty spots in a tray).

In some embodiments, the 2D deep learning model 206 and/or the subsystem 210 can include a component, such as a back-end component of and/or associated with the 2D deep learning model 206. The back-end component can be modified using 2D representations. The back-end component can maintain a plurality of adjustable parameters. The adjustable parameters can be adjusted based on the inspection result (e.g., inspection result 212 of the subsystem 210) and/or a training set of 2D representations.

In some embodiments, the inspection result 212 and/or a training set of 2D representations can include a quality metric that indicates the confidence value of the inspection result 212. The number and/or types of geometric features included in the elements 402 of the 2D map 400 can be modified based on the quality metric. For example, the number and/or types of geometric features in the elements 402 of the 2D map 400 can be modified to optimize the quality metric using a brute force search, a greedy search, or a gradient-descent optimization. A value of the quality metric may be modified such as increased and/or decreased (e.g., according to optimization of a function or value, such as minimizing a function). Alternatively or additionally, the geometric features in the vector can be determined/adjusted by a user of the system 200 based on, for example, user observation and/or the quality metric.

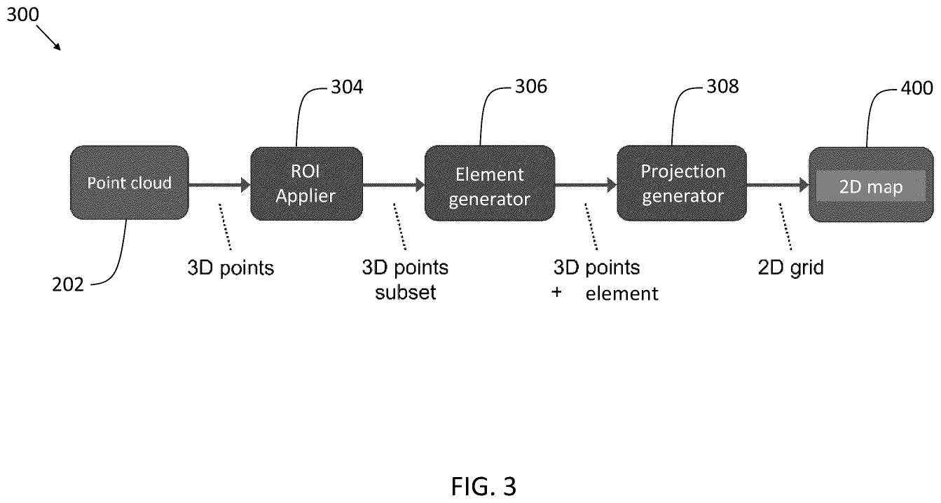

FIG. 3 is a block diagram of an exemplary 2D map generator 300 of the system 200 for 3D inspection, according to some embodiments. The 2D map generator 300 can include a region of interest (ROI) applier 304, an element generator 306, and a projection generator 308. The ROI applier 304 can receive the 3D representation 202 (illustrated as 3D point cloud as an example) and identify a subset of 3D points in the point cloud corresponding to an ROI. The ROI can be any 3D shape, such as a 3D box, a sphere, etc. Optionally, the ROI can be determined by a user of the system 200 for 3D inspection. For example, a user can select a portion of an object to inspect. Referring to FIG. 8, where a task can be to inspect the label on a bottle rather than the whole bottle, a user can create a ROI over the label and exclude the neck of the bottle. Localizing the inspection area can yield more accurate results.

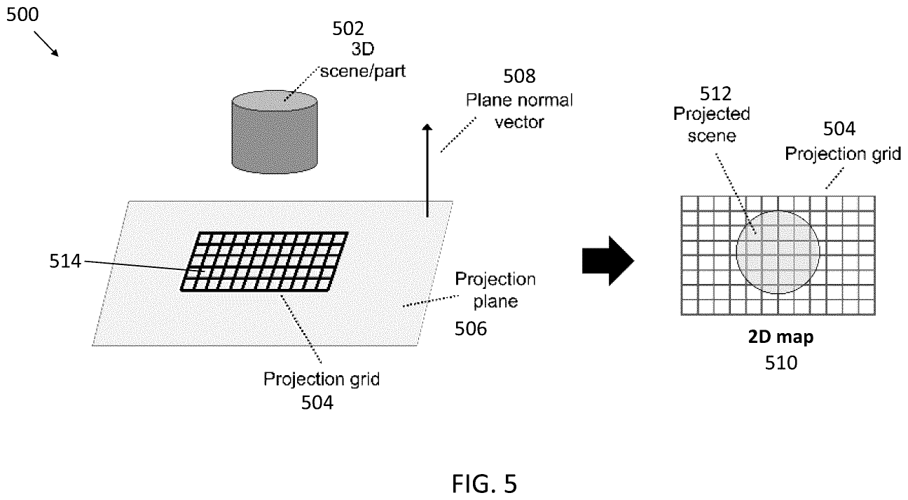

The element generator 306 can be configured to, for each of the subset of 3D points, compute the geometric features and determine, for each of the elements 402 of the 2D map 400, the vector of the geometric features based on the computed geometric features of the subset of 3D points. As described above, examples of geometric features include, but are not limited to, a distance of an associated 3D point of the 3D representation 202 to a reference, a surface normal vector of the associated 3D point, and a curvature associated with the 3D point. Examples of a reference include, but are not limited to, a point, a line, a plane, a hemisphere, a cylindrical surface, or a quadratic surface. The projection generator 308 can include any suitable operation that projects the output of the element generator 306 (e.g., the subset of 3D points and the computed geometric features of the subset of 3D points) to the array 404 of the 2D map 400. An exemplary processing 500 by a projection generator 308 of the 2D map generator 300 is described below with FIG. 5.

In some embodiments, multiple ROIs can be determined based on the inspection task and/or by a user of the system 200 so as to, for example, generate a combined 2D map. The multiple ROIs may or may not overlap. The combined 2D map can be generated by aggregating geometric features of the multiple ROIs, each of which can be represented in a local array, based on poses of the multiple ROIs. Such a configuration can be useful for some applications. For example, to represent a surface that spans a large space while having curvature variation in the spanned space, using one ROI could be challenging since surface feature extraction could be location and orientation dependent. With multiple ROIs, each ROI can provide an oriented focus view responsible for extracting a portion of the surface within the ROI. With multiple overlapped ROIs or a moving sequence of ROIs, a combined 2D map that contains all the surface details in a 2D format, which can be equivalent to a 3D representation of the surface (e.g., unwrapped/flattened), can be generated.

FIG. 5 is a schematic diagram illustrating an exemplary processing 500 by a projection generator 308 of the 2D map generator 300 to project and/or transform a 3D representation 502 (e.g., 3D representation 202 including a captured or processed 3D cloud) to a projected scene 512 in a 2D map 510. As illustrated, a discrete grid 504 is defined on an oriented projection plane 506 that has a plane normal vector 508 (e.g., the plane may be perpendicular to the vertical axis of the coordinate frame). The projection generator 308 can map each 3D point (e.g., a 3D point p=(x,y,z) in a coordinate system of the 3D cloud 502) to an element 514 in the grid 504 (e.g., an element q=(u,v) in the grid 504). The element 514 can include multiple 3D points that are adjacent to the 3D point p.

The projection generator 308 can generate the vector of geometric feature(s) for each element 514 in the grid 504. In some embodiments, the projection generator 308 is configured to, for each element 514 in the grid 504, generate the vector based on one of the multiple 3D points and discarding the rest of the multiple 3D points. For example, the projection generator 308 can be configured to, according to the inspection task that the system 200 is configured for, generate the vector based on the 3D point that has the highest value(s) for the geometric feature(s), the lowest value(s) for the geometric feature(s), or specific criteria such as a range of value(s) for the geometric feature(s). In some embodiments, the projection generator 308 can be configured to, for each element 514 in the grid 504, determine the vector of the geometric feature(s) based on the geometric feature(s) of all of the multiple 3D points (e.g., in the form of a weighted average). For example, each element 514 can store the Euclidean distance from the projected point(s) to the projection plane 506, a unit normal vector corresponding to the projected point(s), and/or the z-component of the unit surface normal vector.

FIGS. 6A-6G show an exemplary inspection task that the system 200 can be configured to perform. FIG. 6A shows side images of an object 602 with two lids 604 and 606, showing one lid 604 open and both lids 604 and 606 closed, respectively. In this example, the task is to identify whether the object 602 under inspection has any of the two lids 604 and 606 open when observed from the top of the object 602. FIG. 6B shows respective top images of the object 602, corresponding to FIG. 6A. As illustrated, the 2D images cannot capture sufficient information to perform the inspection task. FIGS. 6C-6G are respective 2D maps of the object with two lids, corresponding to FIG. 6A, according to some embodiments. As illustrated, the 2D maps can capture geometric features such as heights (FIGS. 6D-6F), local surface orientations (FIG. 6C), and relative angles (FIG. 6G), which enables distinguishing the different configurations of the object 602.

As noted above, the geometric features in the vector can be determined/adjusted based on the inspection task that the system 200 is configured to perform. For instance, the 2D maps can have resolutions configured for individual inspection tasks such that the system can perform the inspection tasks with the required accuracy while not generating more than necessary amount of data. In the illustrated example, while both a 24-bit 2D map of height (FIG. 6D) and an 8-bit 2D map of height (FIG. 6E) can be used for the inspection task to identify whether the object 602 under inspection has any of the two lids 604 and 606 open, the 8-bit 2D map of height (FIG. 6E) can generate less data and therefore require less computation than the 24-bit 2D map of height (FIG. 6D).

As another example, the 2D maps can include absolute values of a geometric feature, which can be, for example, a distance of an associated 3D point to a determined reference (e.g., a point, a line, a plane, a hemisphere, a cylindrical surface, or a quadratic surface). Alternatively or additionally, the 2D maps can include relative values of a geometric feature, which can be, for example, a distance of an associated 3D point with respect to an adjacent 3D point. In the illustrated example, 2D maps of heights shown in FIGS. 6D and 6E can include absolute heights, and the 2D maps of heights shown in FIG. 6F can include relative heights. For this inspection task, while both absolute heights and relative heights can be used to identify whether the object 602 under inspection has any of the two lids 604 and 606 open, the 2D map of relative heights (FIG. 6F) can generate less data and/or data with smaller values and therefore require less computation than the map of absolute heights (FIGS. 6D, 6E). Although absolute heights and relative heights are described herein, the present disclosure is not intended to be limited in this aspect and absolute values and relative values can be used for other geometric features.

FIGS. 7A-7C show another exemplary inspection task that the system 200 can be configured to perform. FIG. 7A is a 3D point cloud 702 of a connector in an exemplary region of interest (ROI) 704. In this example, the task is to identify whether the connector under inspection has any defect and/or the locations of any identified defects. As illustrated, the connector has a defect 706. FIG. 7B is a 2D map 708 generated based on the 3D point cloud 702, according to some embodiments. Each element of the 2D map 708 includes a distance of an associated 3D point of the 3D point 702 to a reference (e.g., a pre-determined reference plane). FIG. 7C is a 2D map 710 generated based on the 3D point cloud 702, according to some embodiments. Each element of the 2D map 710 includes a surface normal vector of an associated point. In this example, the 2D map 708 can identify the defect 706 with higher probability and accuracy than the 2D map 710. An inspection result 212 of the system 200 can provide a higher confidence value for 2D map 708 than 2D map 710. The 2D map generator 300 can be adjusted based on the inspection results 212 to generate 2D maps like 2D map 708 or a combination of 2D maps 708 and 710 for subsequent inspections.

FIGS. 8A-8C show a third exemplary inspection task that the system 200 can be configured to perform. FIG. 8A is a 3D point cloud 802 of a bottle in an exemplary ROI 804. In this example, the task is to identify whether the bottle under inspection has any wrinkles and/or the locations of any identified wrinkles. As illustrated, the bottle has three wrinkles 806a, 806b, 806c. FIG. 8B is a 2D map 808 generated based on the 3D point cloud 802, according to some embodiments. Each element of the 2D map 808 includes a distance of an associated 3D point of the 3D point 802 to a reference (e.g., a pre-determined reference plane). FIG. 8C is a 2D map 810 generated based on the 3D point cloud 802, according to some embodiments. Each element of the 2D map 810 includes a surface normal vector of an associated point. In this example, the 2D map 810 can identify all of the three wrinkles 806a, 806b, 806c with higher probability and accuracy than the 2D map 808. An inspection result 212 of the system 200 can provide a higher confidence value for 2D map 810 than 2D map 808. The 2D map generator 300 can be adjusted based on the inspection results 212 to generate 2D maps like 2D map 810 or a combination of 2D maps 808 and 810 for subsequent inspections.

Additional exemplary inspection tasks are shown in FIGS. 9A-11C. In these examples, the task is to identify defects on target objects and provide segmentation masks indicating the 3D regions where defects have been found. As illustrated, FIGS. 9A, 10A, and 11A are 3D point clouds of an oil filter, a tote, and a battery surface, respectively. FIGS. 9B, 10B, and 11B are 2D maps of the oil filter, tote, and a battery surface, respectively, which can be provided by the 2D map generator 300. FIGS. 9C, 10C, and 11C are segmentation masks of the oil filter, tote, and a battery surface, respectively, which can be provided as the inspection result 212 based on the respective 2D maps shown in FIGS. 9B, 10B, and 11B by the 2D deep learning model 206 and/or the subsystem 210.

In some embodiments, it can be desirable to provide accurate inspection results (e.g., identify a dent) within a limited time period. The techniques described herein provide for focusing computational effort on portion(s) of the process that have a high likelihood of affecting the inspection results. One or more 3D profiles can be generated and provided as 3D representation for inputting into a 2D map generator. The 3D profiles can be generated at locations which can be representative of a neighborhood region. Such a configuration can reduce the amount of data that needs to be processed (e.g., compared to conventional techniques that typically analyze more data) and therefore focus computational effort and/or reduce complexity. The 3D profile may be derived from an initial 3D representation such as a 3D point cloud, a mesh, sensor data, and/or a voxel grid. FIGS. 12-18 describe exemplary methods and systems for 3D inspection using 3D profiles as a 3D representation (e.g., 3D representation 202 shown in FIG. 2).

FIG. 12 is an image illustrating a method of generating a 3D profile, according to some embodiments. The 3D profile may include a plurality of sets of 3D points. Each point and/or set of 3D points may be obtained from an initial 3D representation of a scene (e.g., a 3D point cloud). The 3D points may be obtained according to an associated polyline. FIG. 12 shows a 3D point cloud 1200 overlaid with a 3D region of interest 1204, according to some embodiments. Within the region of interest is a 3D profile which refers to a 2D polyline 1202 that lies in the 3D space. The polyline may be planar or non-planar. The slice, an example of which is the polyline, can be in other formats such as radial shapes. To create 3D profile(s), the machine vision system can determine the 3D points of the 3D point cloud shown within the rectangular 3D region of interest 1204 on a cutting plane 1206 (e.g., which can be user-specified). The cutting plane may represent a cross-section. The 3D profile may be based on the associated polyline including points with non-zero values in a vertical axis of a coordinate frame (e.g., as shown in FIG. 12).

The machine vision system may represent the set of 3D points as a set of 2D points based on coordinate values of the designated first and second axes of set of the 3D points (e.g., for a coordinate form represented by (X,Y,Z), the designated first and second axes can be X and Z, Y and Z, and/or the like). The third axes may be given an artificial coordinate (e.g., the X and Z coordinate may be maintained while an artificial Y coordinate is generated). In some cases, the third coordinate may be maintained such that the set of 3D points are represented as 3D points as opposed to 2D points as described herein.

According to some embodiments, the 3D points can be represented in a 2D plane. According to some embodiments, the 3D points can be represented as 2D points by representing the 3D points using only two of the three coordinate axes values and/or by setting each value of an axis of the set of 3D points (e.g., the third axis) to zero. For example, the Y component of each 3D point along the polyline 1202 may be set to zero, according to some embodiments. The length of the cross section can be pre-configured and/or determined based on the point cloud data. In some embodiments, for example, the width of the point cloud is averaged to obtain the length of the cross section. The size of the cross-section slicing plane may be determined by the scale of the point cloud and/or a user-defined feature size. The cross-section slicing plane may define the length of the cross section. In some examples, the points that form a 3D profile are not present in the originating point cloud. The profile points may be calculated from the point cloud. A parameter may control the distance between points in a profile such that the density of the profiles may change (e.g., depending on the selected parameter). In some embodiments, such as when a less dense profile is generated, less data is subsequently processed.

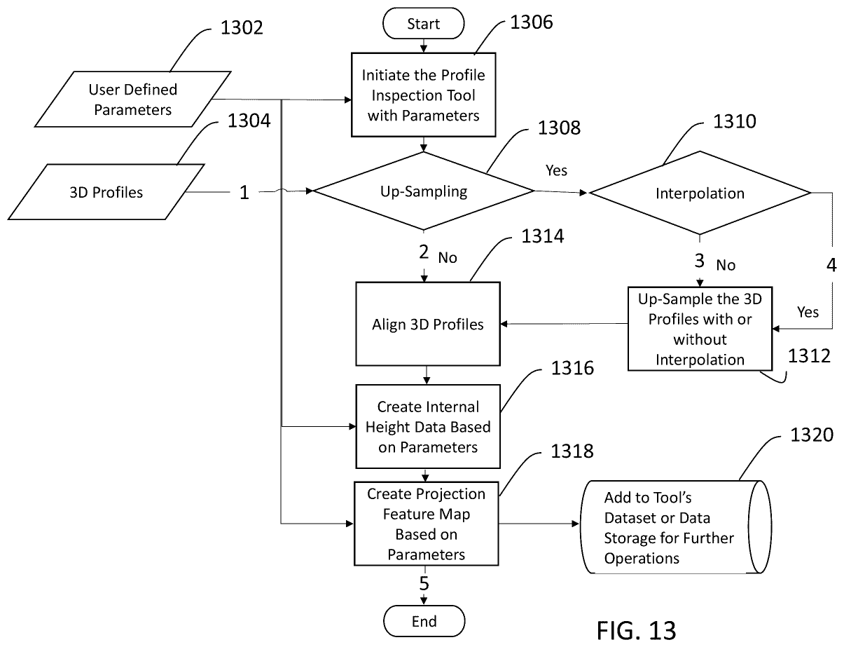

In embodiments in which the 3D representation includes a 3D profile, steps can be performed to prepare the profile for analysis, such as for inspection. The steps may include using a 2D map generator, such as described in relation to FIG. 2. FIG. 13 is a flow chart illustrating an exemplary method of generating a 2D map from 3D profiles with the 2D map generator of FIGS. 2 and/or 3, according to some embodiments. The flow chart includes blocks that may represent data, decisions, processes, and database(s).

As shown in FIG. 13, data 1302 including user defined parameters may be obtained. The user defined parameters may be adjustable parameters. The parameters may be unique to the profile inspection application. The parameters may relate to the projection type.

Data 1304 may also be obtained including at least one 3D profile. The 3D profile(s) may refer to a 2D polyline. The representation of a 3D profile may be 3D points and/or vectors. The representation may vary based on implementation. The 3D profile may be extracted from a point cloud as shown in FIG. 12. The 3D profile (e.g., as shown in FIG. 12) may be accessed as part of a data obtaining or gathering step.

As shown in FIG. 13, process 1306 may include initiating a profile inspection tool with parameters. The parameters may be the user defined parameters of data 1302. The profile inspection tool may be configured to perform the profile inspection techniques discussed herein.

Following initiation of the profile inspection tool, decision 1308 may include determining whether to perform up-sampling operations. After obtaining the 3D profile(s) (e.g., after deriving the 3D profiles of data 1304), the 3D profiles may be input for an up-sampling operation. The operation may include creating additional 3D profiles. A decision may be made to perform up-sampling in instances such as when a single profile including a one-line representation is not sufficient for a model to detect features. When projected from the top, a profile may be represented as a single line on a plane. The up-sampling operation can augment a profile's features and/or defects, in some cases. A decision may be made to perform up-sampling for other reasons, such as for a greater density of profiles since making a profile involves down-sampling.

In an instance in which a decision to up-sample is made, a following decision 1310 may include determining whether to perform interpolation operations. At least some points of the 3D point cloud, mesh, and/or voxel grid may be interpolated. In some embodiments, point representations may be interpolated while conducting up-sampling. Since interpolation may be performed as an up-sampling operation, the interpolation can augment a profile's features and/or defects, in some cases. The interpolation can include creating additional 3D profiles. Referring to FIG. 12, an interpolation operation may include at least some points of 3D point cloud 1200 within 3D region of interest 1204 that may not fall on cutting plane 1206. At least some points may be points surrounding those that fall on cutting plane 1206 (e.g., points near or within a particular distance of polyline 1202, within 3D region of interest 1204). Interpolation can include other points, as the techniques are not so limited. The interpolation techniques may be performed using techniques known for interpolating points (e.g., linear or cubic interpolation, nearest neighbor interpolation, spline interpolation, or polynomial interpolation).

In an instance in which a decision to interpolate is made, process 1312 may include up-sampling with interpolation. Correspondingly, in an instance in which a decision not to interpolate is made, process 1312 may include up-sampling without interpolation.

In an instance in which a decision not to up-sample is made, the techniques may proceed to process 1314 in which 3D profiles are aligned. In an instance in which a decision to up-sample is made, and the corresponding up-sampling is performed, the techniques may similarly proceed to the process 1314. Process 1314 may include aligning 3D profile(s) from data 1304. Alternatively or additionally, process 1314 may include aligning 3D profile(s) from data 1304 and at least one other 3D profile, such as from up-sampling operations. The aligning process may include registration processes such that the profiles share a common coordinate system. In some embodiments, the alignment is based on the profile coordinate space. The alignment can include aligning first points in the profiles or aligning the cutting plane/rectangle 1206 of the profiles. The alignment may include aligning the profiles horizontally.

Following any aligning processes, the techniques may include process 1316 including creating height data based on parameters. The height data is a grid-like representation containing only the heights of the profile points after the alignment process 1314. For process 1316, the user defined parameters may be input. In a non-limiting example, when profiles are aligned, the profiles could be arranged in a grid-like representation containing only heights of the profile points. In such an example, the techniques may have improved storage and may be memory efficient.

Following any processes to create height data, the techniques may include process 1318 including creating transformation and/or projection feature map(s) based on parameters. For this process, the user defined parameters may be input. Other input data, including the data output at numbered arrows 2, 3, and 4, may be in binary format. The data output at numbered arrows 2, 3, and 4 may be aligned prior to creating the projection feature maps.

The projection feature map (e.g., a 2D map) may be created as described herein (e.g., in relation to the 2D map generator of FIG. 3). For clarity, and as an example, the height information of one 3D profile can be projected onto a row of pixels on a 2D grid. In some embodiments, the 2D map represents at least one dimension of each of the 3D points (e.g., of sets of 3D points) of the 3D profile using a geometric feature, which may correspond to the format of a grayscale image on a plane. The plane may be perpendicular to a vertical axis of a coordinate frame of which the profile comprises non-zero values (as discussed herein). The projection can be changed based on the user-defined parameter settings. The pixel value of the 2D grid could depend on neighboring aligned profiles if a user selects a projection mode other than grayscale mode or heightmap, as an example. Depending on up-sampling and interpolation as well as the projection mode, one profile point could contribute to multiple pixel values in the 2D grid. While some examples may involve a “vertical” axis, in other examples, another orientation, such as relative to a horizontal axis may additionally or alternatively be used, as the techniques are not so limited.

The projection feature map generated at process 1318 may be added to the tool's dataset or data storage, corresponding to database 1320, for further operations. In some embodiments, the 2D map is provided to a 2D deep learning model to generate an output from the 2D deep learning model, such as described herein. That output may be provided to a subsystem for generating an inspection result for the 3D profile.

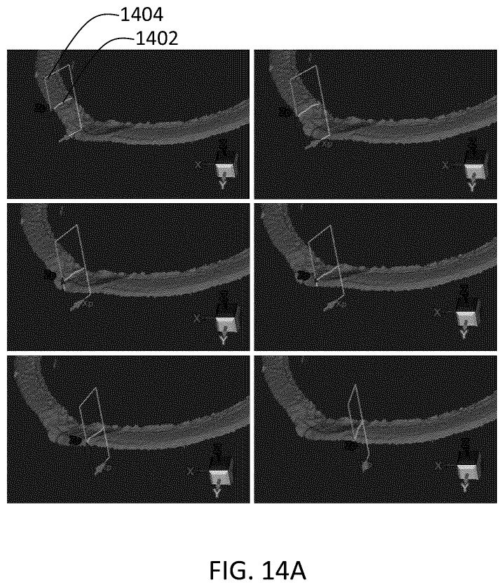

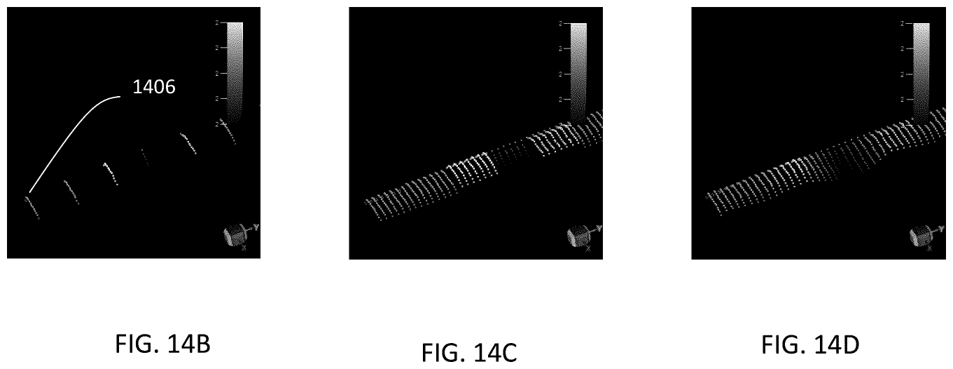

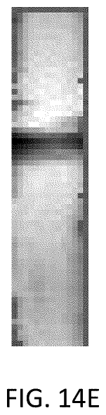

Each of FIGS. 14A-14E correspond to the numbered arrows 1-5 as shown in FIG. 13. As an example, FIG. 14A depicts exemplary 3D profiles corresponding to numbered arrow 1.

In more detail, FIG. 14A shows images illustrating exemplary profiles on an original point cloud in a 3D view. In FIG. 14A, six profiles are shown. Each profile may lie on a 2D plane. The images display each profile 1402 overlaid on its originating point cloud. Each profile may refer to a polyline. The 2D cutting planes 1404 are shown along with an X-Z axis indicator.

FIG. 14B shows the six profiles 1406 of FIG. 14A corresponding to numbered arrow 2 of FIG. 13. The 3D profile(s) may include a plurality of sets of 3D points. While in the flow chart of FIG. 13, the profiles are not yet aligned at numbered arrow 2, in the illustrated configuration, the profiles have been aligned and are in 3D points. For clarity, the illustrated profiles were not up-sampled. Each group of points represents one profile.

FIG. 14C is an alternative arrangement to that shown in FIG. 14B, corresponding to numbered arrow 3, in which up-sampling is performed without interpolation. In the illustrated example, each profile is repeated seven times (e.g., a repetition mode of up-sampling). The parameter used for up-sampling is seven in this example. While in the flow chart of FIG. 14A, the profiles are not yet aligned at numbered arrow 3, in the illustrated configuration, the profiles have been aligned and are in 3D points.

FIG. 14D shows another alternative arrangement to that shown in FIG. 14B, corresponding to numbered arrow 4, in which up-sampling is performed with interpolation. The interpolation techniques may be applied to create a smooth transition between added (e.g., interpolated) profiles. While in the flow chart of FIG. 14A, the profiles are not yet aligned at numbered arrow 4, in the illustrated configuration, the profiles are aligned and in 3D points.

FIG. 14E shows an example of a projection feature map, corresponding to numbered arrow 5 in FIG. 13. The visual features of the feature map may vary according to the chosen projection mode. As an example, the feature map may be generated according to a projection mode selected from among: height map, normal map, adaptive height map, free form surface map, curved surface map, and intensity image.

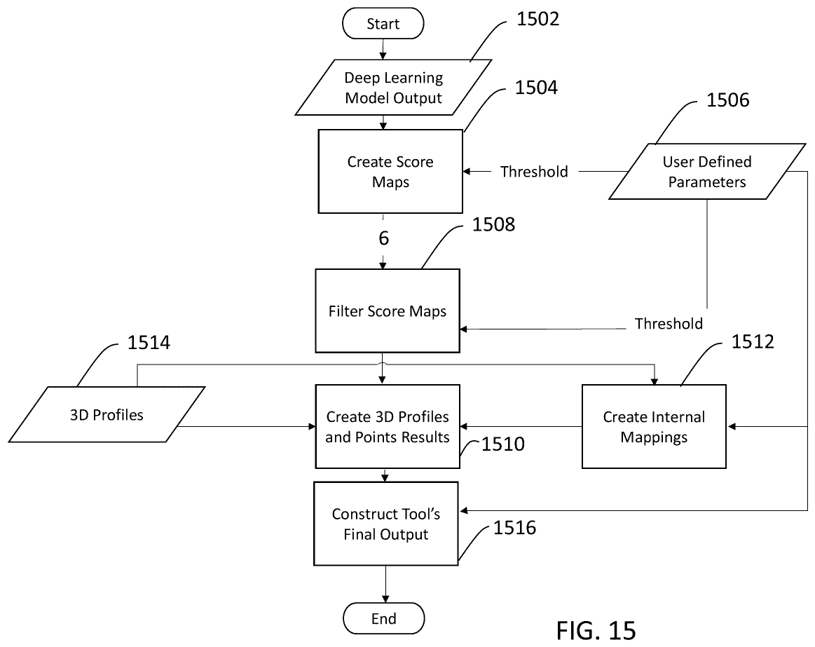

FIG. 15 is a flow chart illustrating an exemplary method of providing inspection results based on output of the 2D deep learning model with the subsystem of FIG. 3, according to some embodiments. The flow chart includes some post processing techniques.

As shown in FIG. 15, data 1502 including deep learning model output may be obtained and may be input for a process 1504. As discussed herein, the output of the 2D deep learning model can include 2D information about the scene.

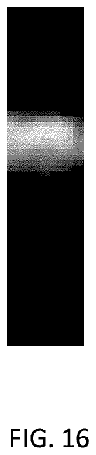

Process 1504 can include creating score maps, an example of which is discussed in relation to FIG. 16. The score map may display probabilities in relation to the inspection task (e.g., probability of being a defect). The inspection task may relate to types of defects which can be defined as categories of the tool for model training. If a tool is configured with multiple categories, the tool can recognize different types of defects, as an example. Each score map may correspond to one category; therefore, the tool may generate multiple score maps if there are multiple categories (e.g., bump, dent, etc.).

The score map may be based on the output from the 2D deep learning model. The score map may display deep learning model predictions with a 2D image-like representation (e.g., an image mask). The score map may be created by applying filters and conversions to the deep learning model output. The score map may be created based on input vectors or probabilities of each pixel belonging to or matching each category (e.g., defect category). The score map may be created based on data 1506 including user defined parameters. The score map may have a same height and width as the corresponding feature map. Each pixel on the score map may be a prediction score corresponding to the location on the feature map.

For a score map being generated in grayscale, as an example, the probability values may range from 0 to 1 with the generated image including pixels corresponding to the values ranging from 0 to 1. The user defined parameters may include a threshold. The threshold may be a value to compare probability values to. In some embodiments, the threshold may support multi-category detection and/or inspection. When a score map of a category is generated, a pixel with a score value greater than or equal to the threshold (e.g., the threshold identified in FIG. 15) is considered to belong to the corresponding category.

After creating score maps, the techniques may proceed to process 1508 in which the score maps are filtered. User defined parameters may be provided as an input to the filtering process. The user defined parameters may include another threshold. The threshold may be a value to compare probability values to, such as 0.8. In the example of a grayscale score map, any pixel values greater than the threshold may be taken as a defect, for example. Correspondingly, any pixel values less than the threshold may not be taken as a defect. During the filtering process, the score map may not change.

After filtering, the techniques may proceed to process 1510 including creating 3D profiles and points results. The results may include identified profiles (e.g., profiles with a defect). Data 1514 including 3D profiles may be provided as input. Internal mappings created at process 1512 may also be provided as input. The internal mappings may be created based at least in part on user defined parameters and the 3D profiles, each of which may be provided as input. In addition, a mathematical representation of the output indicated by numbered arrow 6 after filtering may be input. The filtered score maps may conceptually resemble the example score map shown in FIG. 16.

Alternatively or additionally, the data format to be filtered and used for creating results in FIG. 15 may be 3D profiles or 3D points themselves (e.g., not score maps). This format may directly map and reveal model prediction results in the original 3D data representations. The 3D data representations may encompass point clouds, mesh, voxel grids, and profile sets. This type of format may be created by applying filtering directly to the deep learning model output with mapping to the 3D space.

After creating the 3D profiles and points results, the tool's final output may be constructed at process 1516. User defined parameters may be input for determining the final output as well. In some embodiments, the output could be an inspection result as discussed herein. The inspection result may be generated based on the output from the 2D deep learning model.

As discussed in relation to FIG. 15, score maps may be created and used as a likelihood metric. FIG. 16 shows an example of a score map corresponding to the numbered arrow 6 in FIG. 15. The score map is an intensity image displaying probabilities. The probability values from 0 to 1 are mapped from 0 (black) to 255 (white) in pixel values. The area in FIG. 16 that is brighter than other areas would refer to a region that has a higher probability of being a defect in a defect inspection application, as an example. The value 0 may correspond to an indication of a defect being unlikely and the value of 1 may correspond to an indication of a defect being very likely. The values in between 0 and 1 may correspond to indications of varying degrees of probability of being a defect. In some embodiments, the score maps may be used as a likelihood metric in making decisions. There may be a threshold value such that a decision can be made based on the threshold. A value greater than the threshold may be decided as a defect, and a value less than the threshold may be decided as not a defect.

The score map can be mapped to the original profile. In some embodiments, the mapping would not be a one-to-one mapping due to up-sampling operations. Since the transformation from 3D to 2D is a known transformation, the re-mapping can be performed.

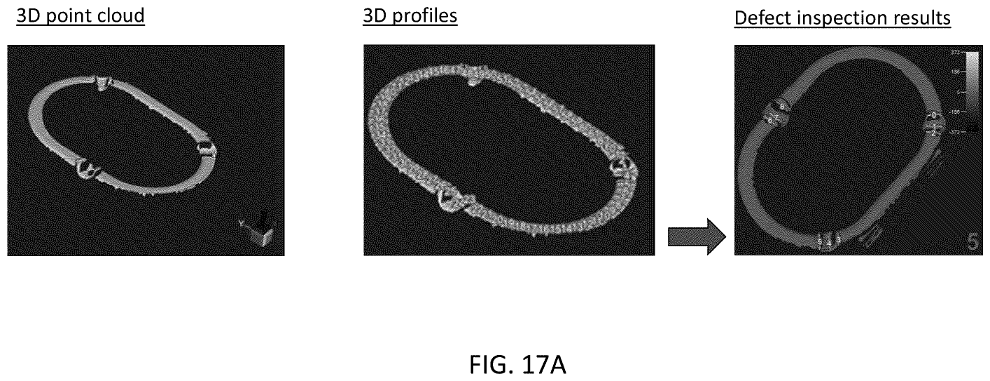

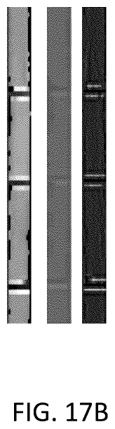

FIG. 17A shows images illustrating generating defect inspection results of a point cloud with the methods of FIGS. 13 and 15. FIG. 17A shows a 3D point cloud, a plurality of 3D profiles, and defect inspection results according to the techniques discussed herein. The plurality of 3D profiles may correspond to a sample that is accessed to carry out the methods described herein.

FIG. 17B shows images of projections corresponding to the step indicated by the arrow in the process shown in FIG. 17A generated prior to the defect inspection results. The different projections correspond to different projection modes. From left to right, the profile projections correspond to a height map mode, normal mode, and free form surface mode, respectively. The profile projection images have a height corresponding to the number of profiles. The dark area may represent an empty portion (e.g., indicating a defect) with profiles stacked around.

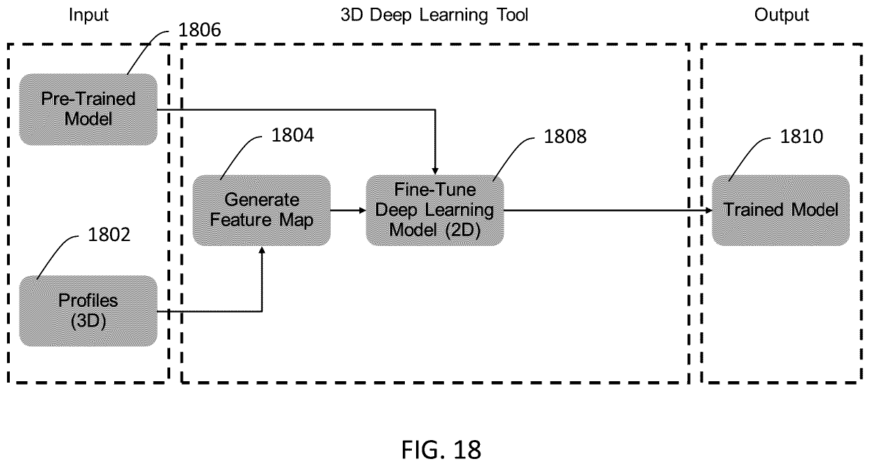

As discussed herein, 3D profiles may be input to a 3D deep learning tool. FIG. 18 is a block diagram illustrating a method of training the 3D deep learning model of FIG. 3. The method may be implemented by an exemplary system (e.g., a 3D deep learning tool). 3D profiles 1802 may be input for implementing an act 1804 (e.g., by the 3D deep learning tool) including generating feature map(s).

The 3D profiles may be a set of 3D profiles to be used to fine-tune a pre-trained model. The pre-trained model 1806 may be input for implementing an act 1808 (e.g., by the 3D deep learning tool) of fine-tuning a deep learning model. A user may draw on the set of profiles to identify a defect such that the tool can be trained to find such a defect. The tool may be trained to identify profiles with defects. A trained model 1810 may be the output of the system implementing such a method. A user may verify that the tuned model functions as appropriate for the target application or may repeat the process to re-train the model if needed. The user may then deploy the tool for runtime usage. The result of the tool may include score maps and identified profiles and points, as discussed herein.

Techniques operating according to the principles described herein may be implemented in any suitable manner. The processing and decision blocks of the diagrams above represent steps and acts that may be included in algorithms that carry out these various processes. Algorithms derived from these processes may be implemented as software integrated with and directing the operation of one or more single-or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the diagrams included herein do not depict the syntax or operation of any particular circuit or of any particular programming language or type of programming language. Rather, the diagrams illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each diagram is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

It should be understood that the above-described acts of the methods described herein can be executed or performed in any order or sequence not limited to the order and sequence shown and described. Also, some of the above acts of the methods described herein can be executed or performed substantially simultaneously where appropriate or in parallel to reduce latency and processing times.

All definitions, as defined and used, should be understood to control over dictionary definitions, definitions in documents incorporated by reference, and/or ordinary meanings of the defined terms.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

Various aspects are described in this disclosure, which include, but are not limited to, the following aspects:

1. A method for three-dimensional (3D) inspection using a two-dimensional (2D) deep learning model, the method comprising: accessing the 2D deep learning model, wherein the 2D deep learning model was pre-trained using 2D images unrelated to an inspection task for the 3D inspection; accessing a 3D representation of a scene; transforming the 3D representation to a 2D map, wherein the 2D map comprises a plurality of elements disposed in an array, and each of the plurality of elements comprises a vector of a geometric feature computed from the 3D representation; providing the 2D map to the 2D deep learning model to generate an output; and providing the output to a subsystem for generating an inspection result for the 3D representation.

2. The method of aspect 1 or any other aspect, wherein: the 3D representation comprises a 3D point cloud, a mesh, sensor data, and/or a voxel grid.

3. The method of aspect 1 or aspect 2 and/or any other aspect, wherein the geometric feature comprises: a distance of an associated 3D point of the 3D representation to a reference; a surface normal vector of the associated 3D point; and/or a curvature associated with the 3D point.

4. The method of any one of aspects 1-3 and/or any other aspect, wherein: the reference is a plane, a hemisphere, a cylindrical surface, or a quadratic surface.

5. The method of any one of aspects 1-4 and/or any other aspect, wherein, for each of the plurality of elements: the vector comprises a number of geometric features; and the number of geometric features is one, two, or three.

6. The method of any one of aspects 1-5 and/or any other aspect, wherein transforming the 3D representation to the 2D map comprises: determining a portion of the 3D representation that corresponds to one of the plurality of elements of the 2D map; and for the portion, computing the vector of the geometric feature for the corresponding element of the 2D map.

7. The method of any one of aspects 1-6 and/or any other aspect, wherein: the 3D representation comprises a 3D point cloud comprising a plurality of 3D points; and for the portion, computing the vector of the geometric feature for the corresponding element comprises: computing the geometric feature for the 3D points in the portion; and determining the vector of the geometric feature for the corresponding element based on the computed geometric feature for the 3D points in the portion.

8. The method of any one of aspects 1-7 and/or any other aspect, wherein transforming the 3D representation to the 2D map comprises: projecting the computed vectors for the plurality of elements to a plane.

9. The method of any one of aspects 1-8 and/or any other aspect, wherein: the inspection result comprises a 3D result.

10. The method of any one of aspects 1-9 and/or any other aspect, wherein: the 3D result comprises one or more of a height, surface area, center of mass, volume, or 3D bounding box in the 3D representation.

11. The method of any one of aspects 1-10 and/or any other aspect, further comprising: classifying an object via the subsystem.

12. The method of any one of aspects 1-11 and/or any other aspect, further comprising: determining, via the subsystem, whether the object is in the 3D representation of the scene.

13. The method of any one of aspects 1-12 and/or any other aspect, further comprising: identifying, via the subsystem, a possible defect of an object.

14. The method of any one of aspects 1-13 and/or any other aspect, wherein: the inspection result comprises a segment of the 3D representation associated with the possible defect.

15. The method of any one of aspects 1-14 and/or any other aspect, wherein: the 2D deep learning model and/or the subsystem comprises a back-end component that maintains an adjustable parameter.

16. The method of any one of aspects 1-15 and/or any other aspect, comprising: adjusting the parameter based on the inspection result generated by the subsystem.

17. The method of any one of aspects 1-16 and/or any other aspect, comprising: adjusting the parameter based on a training set of 2D maps.

18. The method of any one of aspects 1-17 and/or any other aspect, wherein: the inspection result comprises a quality metric; and the method comprises modifying the geometric feature based on the quality metric.

19. The method of any one of aspects 1-18 and/or any other aspect, wherein: modifying the geometric feature based on the quality metric comprises a brute force search, a greedy search, or a gradient-descent optimization, such that a value of the quality metric is modified.

20. The method of any one of aspects 1-19 and/or any other aspect, wherein the 3D representation comprises one or more 3D profiles comprising a plurality of 3D points, wherein each 3D point is obtained from an initial 3D representation of the scene based on an associated polyline.

21. The method of any one of aspects 1-20 and/or any other aspect, wherein transforming the 3D representation comprises transforming the one or more 3D profiles to the 2D map.

22. The method of any one of aspects 1-21 and/or any other aspect, wherein the inspection result is based on the one or more 3D profiles.

23. A method for three-dimensional (3D) inspection using a two-dimensional (2D) deep learning model, the method comprising: accessing one or more 3D profiles, wherein the one or more 3D profiles comprise a plurality of 3D points, wherein each 3D point is obtained from an initial 3D representation of a scene based on an associated polyline; transforming the one or more 3D profiles to a 2D map, wherein the 2D map represents a dimension of each of the plurality of 3D points using a geometric feature; providing the 2D map to the 2D deep learning model to generate an output from the 2D deep learning model; and generating, based on the output from the 2D deep learning model, an inspection result based on the one or more 3D profiles.

24. The method of aspect 23 and/or any other aspect, wherein the associated polyline comprises points with non-zero values in a vertical axis of a coordinate frame.

25. The method of any one of aspects 23-24 and/or any other aspect, further comprising deriving the one or more 3D profiles from the initial 3D representation, wherein the initial 3D representation comprises a 3D point cloud, a mesh, sensor data, and/or a voxel grid.

26. The method of any one of aspects 23-25 and/or any other aspect, further comprising, after deriving the one or more 3D profiles, performing an up-sampling operation to create a second 3D profile.

27. The method of any one of aspects 23-26 and/or any other aspect, further comprising interpolating points of the 3D point cloud, mesh, sensor data, and/or voxel grid to create the second 3D profile.

28. The method of any one of aspects 23-27 and/or any other aspect, further comprising aligning a plurality of the one or more 3D profiles prior to transforming the one or more 3D profiles into the 2D map.

29. The method of any one of aspects 23-28 and/or any other aspect, further comprising creating a score map based on the output from the 2D deep learning model.

30. The method of any one of aspects 23-29 and/or any other aspect, wherein accessing the one or more 3D profiles includes accessing a sample comprising a plurality of 3D profiles.

31. The method of any one of aspects 23-30 and/or any other aspect, wherein the 2D map represents the dimension of each of the plurality of 3D points using the geometric feature corresponding to a format of a grayscale image on a plane perpendicular to the vertical axis of the coordinate frame.

32. The method of any one of aspects 23-31 and/or any other aspect, wherein the one or more 3D profiles comprise a plurality of sets of 3D points.

33. A system comprising at least one processor configured to perform one or more operations in any of the methods of any of the aspects.

34. A non-transitory computer readable medium comprising program instructions that, when executed, cause at least one processor to perform one or more operations in any of the methods of any of the aspects.

What is claimed is:

1. A method for three-dimensional (3D) inspection using a two-dimensional (2D) deep learning model, the method comprising:
accessing the 2D deep learning model, wherein the 2D deep learning model was pre-trained using 2D images unrelated to an inspection task for the 3D inspection;
accessing a 3D representation of a scene;
transforming the 3D representation to a 2D map, wherein the 2D map comprises a plurality of elements disposed in an array, and each of the plurality of elements comprises a vector of a geometric feature computed from the 3D representation;
providing the 2D map to the 2D deep learning model to generate an output; and
providing the output to a subsystem for generating an inspection result for the 3D representation.

2. The method of claim 1, wherein:
the 3D representation comprises a 3D point cloud, a mesh, sensor data, and/or a voxel grid.

3. The method of claim 1, wherein the geometric feature comprises:
a distance of an associated 3D point of the 3D representation to a reference;
a surface normal vector of the associated 3D point; and/or
a curvature associated with the 3D point.

4. The method of claim 3, wherein:
the reference is a plane, a hemisphere, a cylindrical surface, or a quadratic surface.

5. The method of claim 1, wherein, for each of the plurality of elements:
the vector comprises a number of geometric features; and
the number of geometric features is one, two, or three.

6. The method of claim 1, wherein transforming the 3D representation to the 2D map comprises:
determining a portion of the 3D representation that corresponds to one of the plurality of elements of the 2D map; and
for the portion, computing the vector of the geometric feature for the corresponding element of the 2D map.

7. The method of claim 6, wherein:
the 3D representation comprises a 3D point cloud comprising a plurality of 3D points; and
for the portion, computing the vector of the geometric feature for the corresponding element comprises:
computing the geometric feature for the 3D points in the portion; and
determining the vector of the geometric feature for the corresponding element based on the computed geometric feature for the 3D points in the portion.

8. The method of claim 6, wherein transforming the 3D representation to the 2D map comprises:
projecting the computed vectors for the plurality of elements to a plane.

9. The method of claim 1, wherein:
the inspection result comprises a 3D result, and the 3D result comprises one or more of a height, surface area, center of mass, volume, or 3D bounding box in the 3D representation.

10. (canceled)

11. The method of claim 1, further comprising:
classifying an object via the subsystem.

12. The method of claim 11, further comprising:
determining, via the subsystem, whether the object is in the 3D representation of the scene.

13. The method of claim 1, further comprising:
identifying, via the subsystem, a possible defect of an object.

14. The method of claim 13, wherein:
the inspection result comprises a segment of the 3D representation associated with the possible defect.

15. The method of claim 1, wherein:
the 2D deep learning model and/or the subsystem comprises a back-end component that maintains an adjustable parameter.

16. The method of claim 15, comprising:
adjusting the parameter based on the inspection result generated by the subsystem, a training set of 2D maps, or both.

17. (canceled)

18. The method of claim 1, wherein:
the inspection result comprises a quality metric; and
the method comprises modifying the geometric feature based on the quality metric.

19. The method of claim 18, wherein:
modifying the geometric feature based on the quality metric comprises a brute force search, a greedy search, or a gradient-descent optimization, such that a value of the quality metric is modified.

20. The method of claim 1, wherein the 3D representation comprises one or more 3D profiles comprising a plurality of 3D points, wherein each 3D point is obtained from an initial 3D representation of the scene based on an associated polyline.

21. The method of claim 20, wherein transforming the 3D representation comprises transforming the one or more 3D profiles to the 2D map.

22. The method of claim 21, wherein the inspection result is based on the one or more 3D profiles.

23. A system comprising at least one processor configured to perform:
accessing the 2D deep learning model, wherein the 2D deep learning model was pre-trained using 2D images unrelated to an inspection task for the 3D inspection;
accessing a 3D representation of a scene;
transforming the 3D representation to a 2D map, wherein the 2D map comprises a plurality of elements disposed in an array, and each of the plurality of elements comprises a vector of a geometric feature computed from the 3D representation;
providing the 2D map to the 2D deep learning model to generate an output; and
providing the output to a subsystem for generating an inspection result for the 3D representation.

24. A non-transitory computer readable medium comprising program instructions that, when executed, cause at least one processor to perform;
accessing the 2D deep learning model, wherein the 2D deep learning model was pre-trained using 2D images unrelated to an inspection task for the 3D inspection;
accessing a 3D representation of a scene;
transforming the 3D representation to a 2D map, wherein the 2D map comprises a plurality of elements disposed in an array, and each of the plurality of elements comprises a vector of a geometric feature computed from the 3D representation;
providing the 2D map to the 2D deep learning model to generate an output; and
providing the output to a subsystem for generating an inspection result for the 3D representation.

25-36. (canceled)
